(19) United States
(12) Patent Application Publication
(10) Pub. No.: US 2004/0098243 A1
(43) Pub. Date: May 20, 2004

(54) Simulation and data manipulation

(75) Inventor: Sean M. Kinsey, Stroud (GB)

Correspondence Address: OLIFF & BERRIDGE, PLC, P.O. BOX 19928, ALEXANDRIA, VA, 22320, US

(73) Assignee: Renishaw plc., Gloucestershire (GB)

(21) Appl. No.: 10/299,864

(22) Filed: Nov. 20, 2002

(51) Int. Cl. G06F 9/45

(52) U.S. Cl. 703/22

(57) ABSTRACT

A method of simulating data manipulation is disclosed whereby data which is related to a parameter is obtained from a source, a parameter is changed, and the effect of changing the parameter is simulated on the obtained data by, for example, a visual, written or verbal indication. The data may be related to a plurality of parameters and at least one parameter is changed. The data may be analysed prior to changing a parameter whereby the obtained data is compared to ideal data. The analysed data may undergo a diagnosis step to diagnose which parameter is likely to be responsible for the difference between obtained and ideal data. The data may be test data from a calibration process for example from a ball bar test. The simulation may use a mathematical model.

### BACKGROUND OF THE INVENTION

This invention relates to the simulation of data manipulation and, in particular, to the simulation of the manipulation of test data.

In some circumstances, it is desirable to manipulate data. In this way, the effect of certain parameters which are related to the data may be, established or predicted. There are two ways to achieve this, either by interpolation based on the known behaviour of the data with respect to a parameter or by predetermining the effect of the parameter on the data within certain circumstances (mapping the effect).

It is also desirable that the data is not corrupted by this manipulation such that the original or unmanipulated data is retained.

### SUMMARY OF THE INVENTION

According to a first aspect of the invention there is provided a method of simulating data manipulation comprising the steps of:

obtaining data from a source wherein the data is related to a parameter;

changing the parameter; and

simulating the effect of changing the parameter on the obtained data.

Preferably the obtained data is related to a plurality of parameters and at least one parameter is changed.

In a preferred embodiment, the obtained data is analysed prior to changing a parameter. This analysis data may be achieved by comparing the obtained data to ideal data.

Preferably, prior to changing the parameter, the analysed data undergoes a diagnosis step to diagnose which parameter is likely to be responsible for the difference between obtained and ideal data.

In a preferred embodiment the simulation, of the effect of changing the parameter includes a visual, written, or verbal indication. Preferably, the obtained data is test data, for example, from a calibration process.

The parameters include testing factors such as environmental conditions and testing errors due to incorrect performance of a test as well, as ones which result from the source of the obtained data for example, a machine on which a test is carried out.

According to a second aspect of the invention there is provided a method of simulating the manipulation of test data comprising the steps of:

obtaining test data wherein the test data is related to at least one parameter;

analysing the test data;

changing at least one parameter; and

simulating the effect of changing the at least one parameter on the test data.

Preferably, the analysis of the data is achieved by comparing the obtained data to ideal data.

Preferably after analysis of the test data, the data is diagnosed in a diagnosis step which determines which of the parameters are likely to be responsible for the departure of the test data from the ideal data.

In a preferred embodiment, the diagnosed data is input or exported into a simulator for the steps of changing at least one parameter and simulating the effect of said change.

Preferably, the test data is from a ball bar test.

In a preferred embodiment, the steps of diagnosing and simulating the change of a parameter uses a mathematical model.

Preferably, the mathematical model describes machine errors.

Additionally or alternatively, the mathematical model describes the manner in which machine errors affect the test data provided by the ball bar test.

The simulation of data manipulation such as described herein enables a person who has data, perhaps by performing a test, to alter parameters that affect the data in order to ascertain either how a parameter or combination of parameters affects the data or, which of the parameters needs to be changed in order to decrease the difference between the obtained or test data and the ideal data either by showing the parameter value or the correction required in one example, where data is obtained from a calibration process of a machine having relatively movable parts, for example a machine tool, this manipulation of the data by adjustment of individual parameters in a sequential manner enables the effect of changing each parameter individually or combined to be simulated, thus enabling it to be established how each of the parameters individually or in combination effect the test data. For example, identification of which parameter or combination thereof causes the most difference between test data and the ideal data i.e. what a perfect machine would give as test results. Each parameter may have more than one source of error or difference from the ideal data thus, by identifying which of the parameters has the greatest effect on the data in the simulation the probable error sources can be identified. This in turn may identify the minimum number of machine adjustments or checks required to bring the machine, either to the ideal test data position or to within an acceptable tolerance thereof.

It is also possible that the effect of one parameter on the data can be replicated by the interaction of at least two other parameters and thus, the diagnosis may be incorrect by identifying the one parameter. The simulation step of this, invention should enable identification of such misdiagnosis.

### BRIEF DESCRIPTION OF THE DRAWINGS

The invention will now be described by example and with reference to the accompanying drawings of which:

FIG. 1 is a flow diagram according to the invention;

FIG. 2 shows schematically the effect of the invention; and

FIG. 3 shows an example of a simulation system according to the invention.

### DESCRIPTION OF PREFERRED EMBODIMENTS

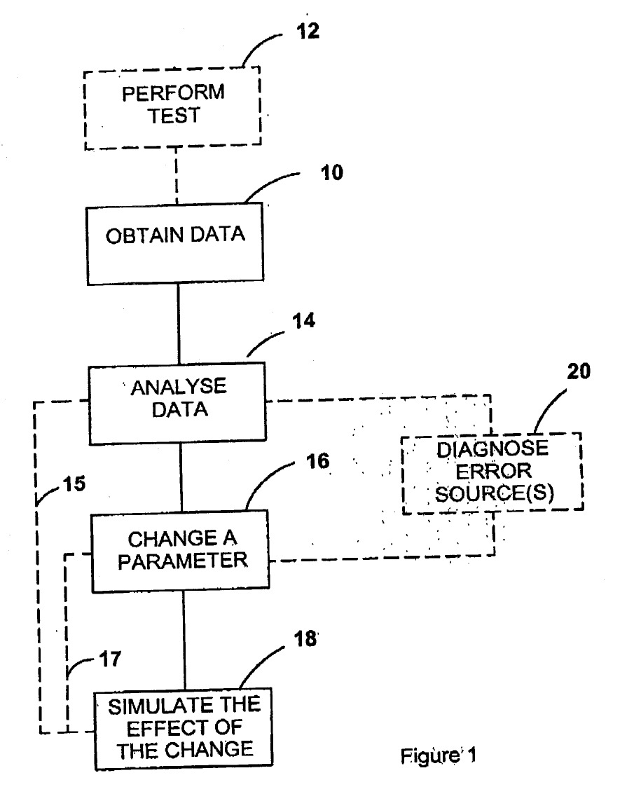

FIG. 1 is a flow diagram which details different steps of the invention. The first step is to obtain data 10, this could either be directly from a test that has been performed 12 or could be supplied from another source. The data is analysed 14 to establish how it compares to an ideal data set or test performance. If it is established that the data is not within an acceptable range of the ideal data, at least one of the parameters that affects the data set is altered 16 and this affect is simulated 18 on the analysed data. If the simulated effect does not produce the desired result i.e. does not bring the data within the acceptable range, there are three main options. The change in the parameter can be reversed, the simulated test data call be analysed 15 to assess the difference between the simulated test data and ideal data or, alternatively another parameter may be changed 17 and the effect simulated. Prior to changing the parameter 16 the analysed data 14 can undergo a diagnosis step wherein the error sources are diagnosed 20. This diagnosis step 20 enables the parameters that affect the data to be ranked or otherwise ordered based on prior information about the effect of each, parameter on the data to give an indication of which parameter is likely to have caused the biggest deviation between the obtained data and the ideal data.

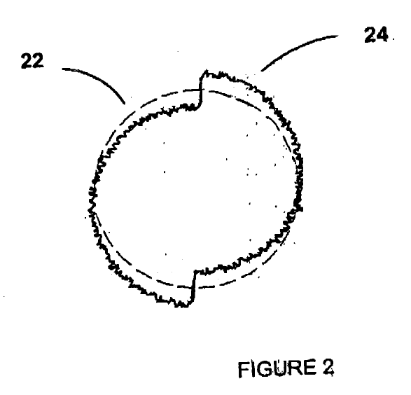

The steps of performing a test 12 and obtaining data 10 may be carried out as one step wherein as the test is performed the data is captured in order to analyse the test data. A visual indication of both the data analysis and the test data obtained may be provided. So if a test is being performed at the same time as data is being obtained this visual indication can show whether or not the test has been completed successfully. The visual indication may be a table, a plot or graph which may show a comparison between the obtained data and the ideal data. An example of the plot is shown in FIG. 2 where the ideal test result 22 is overlaid with the actual test result 24. The test result in FIG. 2 has been obtained from a ball bar test where the machine quill of a machine tool, lathe or CMM for example, is directed to perform two consecutive circular arcs one clockwise and one counter-clockwise.

A ball bar test is a dynamic circular test that detects inaccuracies induced by the machine, machine controller and servo drive systems. A transducer in the ball bar registers changes in the radius of the circle being transcribed. If there are no errors (other than a centring error which has been accounted for and removed from the data plot) the plot will be a true circular plot as indicated by circle 22. However, if there are any machine or test errors then the actual test data plot 24 will deviate from the circle in one of a number of ways. The analysis of the data determines the amount or proportion of error for the plot in x and y directions as well as scale mismatch and any other useful figures.

For a ball bar test, the analysis of the data may take the form of reproducing a plot of the actual ball bar test i.e. the information received frog the ball bar transducer is analysed so as to recreate the circle described by the ball bar during the test. Alternatively, the data may be tabulated, in which case it is desirable to have a comparison with, ideal data to assist in interpretation of the data.

The analysed data can optionally be diagnosed to determine which parameters are the most likely and which have the greatest error sources. This diagnosis step uses the same type of deductive method of the analysis step but goes further by linking errors to error sources and then parameters that, are affected by the error source. For the plot shown in FIG. 2, this diagnosis would show backlash as being the parameter associated with the greatest error. For a plot of the type shown in FIG. 2, there area a number of possible causes of the error (error sources), one is that there is play in the drive system of the machine, another is that there may be play in the guideways of the machine, alternatively a backlash error may have been compensated for but the compensation is too great or too small so needs to be adjusted. When diagnosing the data both the analysed data and all the parameters that can affect that data are assessed. It is likely that the test will have a number of different parameter errors which will all combine to determine the shape of the plot. Where there is more than one parameter responsible for the deviation of the test plot 24 from the ideal 22, the diagnosis stage enables these parameters to be ranked or ordered to indicate which parameter error has the greatest effect on the departure of the test data from the ideal position.

In order to be in a position to diagnose the test data, information about the machine is required. This is often in the form of mathematical models. For the current example of a ball bar test which is carried out on a machine, the models required are a follows. Firstly a mathematical model which describes the systematic errors of the machine and secondly, a mathematical model which details how the systematic errors affect the reading of the instrument (ball bar) that is being used to measure the performance of the machine. To enable analysis of the data, a method of deducing the errors of the machine from the collected data is required. This method may be an mathematical model, a least squares fit routine or, an iterative fit such as Monte Carlo analysis. An example of a mathematical model that may be used is formed by considering the real data as a summation of sine and cosine error terms which produce the standard error terms that are used to describe a machine. The first and second models produce derived values for the errors of the machine which are then used with the collected or test data in the analysis step to predict the performance of the machine i.e. in the analysis stage the obtained test result from the collected data is predicted based on the knowledge of the machine.

It there are any differences between the predicted data and the collected data, these residual errors can be applied to the predicted data.

For a machine of the type being described, there are a number of machine parameters which are related to the data. These include parameters which are due to at least one geometric function and/or servo control error. The geometric functions include yaw, pitch, roll, linearity, straightness and squareness (where there is more than one axis).

Once the data has been analysed or, alternatively a parameter error is diagnosed, the simulation of changes to the parameters may begin. Where the data has only been analysed, the choice of which parameters to change may be a somewhat random process i.e. depending on the skill and experience of an operator and also how the analysed data is presented (a plot or a table for example). However, where the diagnoses step is included, the likely parameters are indicated giving a more purposive method. The effect of changing the chosen set parameter is simulated and indicated. The simulated data may be analysed and the plot could be re-drawn to show a new comparison between the ideal data and the simulated test data set. The diagnosis step 20 is advantageous because it enables the parameter errors to be ranked or ordered so as to indicate which parameters are most likely to cause the biggest deviation from the ideal form of the test data plot. This is useful as there is usually a tolerance level within which the machine must operate. Thus by establishing which parameters produce the greatest departure from ideal, it is established which parameters are likely to cause the biggest effect on the plot if they are altered. The highest ranked parameter can be changed and then this change is demonstrated visually on the plot.

Instead of having to check every moving part of the machine for wear, misalignment, straightness, slop or tension, one or more parameters can be changed individually or as a group and the effect of this change can be indicated on the plot so as to determine which machine parts should be checked in order to achieve a change in performance similar to a simulated change which pulls the plot to within tolerance levels. This saves time when fixing a machine so it will pass a calibration process as the likely error sources for each parameter deviation can be pinpointed directly and an indication of the effect of changing one or more error source associated with each of these parameters can be obtained enabling a more methodical calibration process to be conducted.

In some circumstances, the parameter which gives the greatest error may be difficult or impossible to physically change. The simulation in this case, enables changing of other parameters which can be physically altered in order to work around this problem and achieve the desired result.

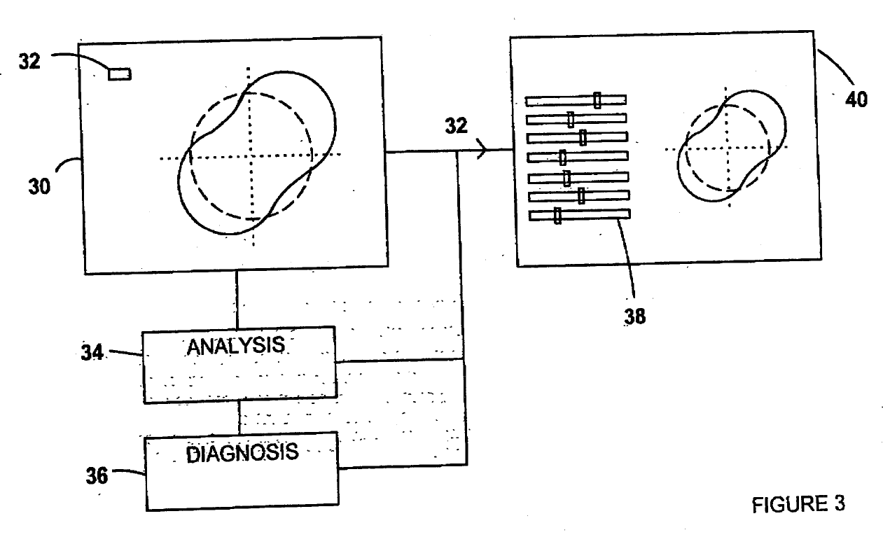

An example of how such a simulation system may work is shown in FIG. 3. A test screen 30 which shows the progress of a test as data is captured includes a link 32 to a separate simulation screen. The data is analysed 34 as it is received from the ball bar which provides an indication of the manner by which the test data deviates from the idea or perfect result. The analysed data 34 may undergo a diagnostic step 36 which ranks the various parameters by size of deviation.

To simulate 40 changing the various parameters that have been identified by the analysed or diagnosed data, the link 32 is followed. The link 32 causes importation of the test data (either raw, analysed or diagnosed) into a simulator. This can bee achieved using an Object Request Broker (ORB) such as Component Object Model (COM). This has the effect of separating the simulation procedure from the data thus preventing corruption of the source data which is one advantage of the invention.

The imported test data is analysed and optionally diagnosed, if necessary (depending on the format of the imported data). Each diagnosed error, which is the result of a parameter, can be adjusted and this change reflected on the data plot. In the example shown, a movable sliding bar 38 is associated with each parameter and a keyboard stroke or mouse movement can be used to change the position of the bar and thus the error associated with the parameter.

If a particular change or changes does not have the desired effect, then it can be reversed either by manually returning the bar to its initial position or, by provision of a reset button which resets all bars to the an analysed or as diagnosed position.

If a change has the desired effect and brings the test data within acceptable tolerance levels, then the causes of the deviation of the now altered parameter can be investigated. In the example given in FIG. 2 there are three or four sources of error that may be causing the parameter error. This limits the amount of machine parts that need to be checked.

An alternative method of producing the simulation is to incorporate it as a part of the test program or link the simulator to the test program so that a simulated change on the simulator will produce a change in the test data in which case there is no importation of data via a link. It is still advisable to use a copy of the test data in order to prevent corruption of it. If the simulation is incorporated into the test program, the screens 30 and 40 would be combined.

The simulator conveniently uses the same mathematical models as the diagnosis step in order to establish what the effect of a change would have on the data. As an alternative to enabling a user to adjust the sliders by any amount, the simulator can show the required correction, as a figure or by bar position on the slider, in order to remove each parameter error that had been diagnosed.

The analysis 15 of the simulated data may be automatic thus, as each parameter is changed, the resultant simulated data set is analysed and the plot re-drawn.

It may be beneficial to retain a copy of the original plot so that each re-analysed simulated data set may be directly compared to the actual data plot to see how much (or little) improvement is being made.

The sliders 38 are one way to enable the change of a parameter although alternatives such as assigning each parameter a number may be more appropriate in different circumstances.

As a parameter may have more than, one error source, there may be a link between different parameter error sources. The diagnosis step can optionally, compare the highest ranked parameters and the error sources that may be contributing to the deviation to further narrow down the likely culprit. For example, if backlash and squareness parameters are the highest ranked, then as both may be a result of guideway problems, this could be highlighted as the most likely source of the errors and thus should be checked first.

If successive test data for a particular machine is collected, the history of how machine parameters have changed over time is seen. This will show, how certain parameters have degraded over time and may enable a prediction of when the error from a parameter becomes unacceptable. Thus, machine parts may be changed or re-aligned according to this predicted degradation.

1. A method of simulating data manipulation comprising the steps of:
obtaining data from a source wherein the data is related to a parameter;
changing the parameter; and
simulating the effect of changing the parameter on the obtained data.

2. A method according to claim 1 wherein the obtained data is related to a plurality of parameters and at least one parameter is changed.

3. A method according to claim 1 wherein the obtained data is analysed prior to changing a parameter whereby the obtained data is compared to ideal data.

4. A method according to claim, 3 wherein prior to changing the parameter, the analysed data undergoes a diagnosis step to diagnose which parameter is likely to be responsible for the difference between obtained and ideal data.

5. A method according to claim 4 wherein the diagnosed data is input or exported into a simulator for the steps of changing at least one parameter and simulating the effect of said change.

6. A method according to claim 1 wherein the simulation of the effect of changing the parameter includes a visual, written, or verbal indication.

7. A method according to claim 1 wherein the obtained data is test data.

8. A method according to claim 7 wherein, the test data is from a calibration process.

9. A method according to claim 1 wherein the step of simulating the change of a parameter uses a mathematical model.

10. A method of simulating the manipulation of test data comprising the step of:
obtaining test data wherein the test data is related to at least one parameter;
analysing the test data whereby the test data is compared to ideal data;
changing at least one parameter; and
simulating the effect of changing the at least one parameter on the test data.

11. A method according to claim 10 wherein after analysis of the test data, there is a diagnosis step which determines which of the parameters are likely to be responsible for the departure of the test data from the ideal data.

12. A method according to claim 11 wherein the diagnosed data is input or exported into a simulator for the steps of changing at least one parameter and simulating the effect of said change.

13. A method according to claim 10 wherein the step of simulating the change of a parameter uses a mathematical model.

14. A method of simulating the manipulation of ball bar test data comprising the steps of:
obtaining ball bar test data from a machine wherein the test data is related to at least one parameter;
analysing the ball bar test data;
changing at least one parameter; and
simulating the effect of changing the at least one parameter on the ball bar test data.

15. A method according to claim 14 wherein after analysis of the ball bar test data, there is a diagnosis step which determines which of the parameters are likely to be responsible for the departure of the test data from the ideal data.

16. A method according to claim 15 wherein the diagnosed data is input or exported into a simulator for the steps of changing at least one parameter and simulating the effect of said change.

17. A method according to claim 15 wherein the step of simulating the change of a parameter uses a mathematical model.

18. A method according to claim 17 wherein the mathematical model describes machine errors.

19. A method according to claim 15, or claim 17 wherein the mathematical model describes the manner in which machine errors affect the test data provided by the ball bar test.

20. A method according to claim 15 wherein the step of diagnosing the change of a parameter uses a mathematical model.

21. A method according to claim 20 wherein the mathematical model describes machine errors.

22. A method according to claim 15 or claim 20 wherein the mathematical model describes the manner in which machine errors affect the test data provided by the ball bar test.
